(19) United States
(12) Patent Application Publication
(10) Pub. No.: US 2011/0201536 A1
(43) Pub. Date: Aug. 18, 2011

(54) METHOD FOR IMPROVING THE CLEANING ACTION OF A DETERGENT OR CLEANING AGENT

(75) Inventors: Timothy O'Connell, Dusseldorf (DE); Petra Siegert, Haan (DE); Stefan Evers, Mettmann (DE); Johannes Bongaerts, Dormagen (DE); Thomas Weber, Dormagen (DE); Karl-Heinz Maurer, Erkrath (DE); Cornelius Bessler, Dusseldorf (DE)

(73) Assignee: Henkel AG & Co. KGaA, Dusseldorf (DE)

(21) Appl. No.: 13/026,491

(22) Filed: Feb. 14, 2011

Related U.S. Application Data
(63) Continuation of application No. PCT/EP2009/058789, filed on Jul. 10, 2009.

(30) Foreign Application Priority Data
Aug. 20, 2008 (DE) 10 2008 038 479.8

(51) Int. Cl. C11D 3/60

(52) U.S. Cl. 510/321; 510/320; 510/392; 510/393

(57) ABSTRACT

The present invention relates to a method for increasing the cleaning performance of a washing or cleaning agent comprising at least one hydrolytic enzyme by addition of a component capable of synergistic interaction with the enzyme. Components capable of such positive synergistic interaction with hydrolytic enzymes include: (i) an amino acid, a polyamino acid, or derivatives thereof; (ii) a biosurfactant; (iii) a microbial metabolite, and a preparation of a microbial culture supernatant that contains at least 2.5 wt % of (i), (ii), or (iii). Additionally, the present invention comprises a method for washing textiles or hard surfaces with an enzymatic washing or cleaning agent that includes at least one of the components (i), (ii), or (iii) capable of increasing the cleaning performance of the washing or cleaning agent through synergistic interaction with the hydrolytic enzyme.

### CROSS-REFERENCE TO RELATED APPLICATIONS

This application is a continuation of PCT Application Serial No. PCT/EP2009/058789, filed on Jul. 10, 2009, which claims priority under 35 U.S.C. §119 to DE 10 2008 038 479, filed on Aug. 20, 2008. The disclosures PCT/EP2009/058789 and DE 10 2008 038 479 are hereby incorporated by reference in their entirety.

### FIELD OF THE INVENTION

The present invention relates to methods for improving the cleaning performance of a washing or cleaning agent that contains a hydrolytic enzyme.

### BACKGROUND OF THE INVENTION

The use of enzymes in washing and cleaning agents is established in the existing art. They serve to expand the performance spectrum of the relevant agents in accordance with their specific activities. These include, in particular, hydrolytic enzymes such as proteases, amylases, lipases, and cellulases. The first three of these hydrolyze proteins, starch, and fats, respectively, and thus contribute directly to stain removal. Cellulases are used in particular because of their fabric effect. A further group of washing- and cleaning-agent enzymes includes the oxidative enzymes, in particular oxidases that either alone or in interaction with other components serve to bleach surface stains or generate bleaching agents in situ. In addition to these enzymes, which are the subject of continuing optimization, other enzymes are constantly being made available for use in washing and cleaning agents to address specific stains. These additional enzymes include pectinases, β-glucanases, mannanases, or additional hemicellulases for the hydrolysis of specific plant polymers.

The enzymes with the longest history, and contained in practically all modern high-performance washing and cleaning agents, are the proteases. Among these are the serine proteases, which also include the subtilases. These enzymes cause the breakdown of protein-containing stains on the material to be cleaned. Among these in turn, proteases of the subtilisin type (subtilases, subtilopeptidases, EC 3.4.21.62), which are categorized among the serine proteases because of the catalytically effective amino acids, are particularly important. They act as nonspecific endopeptidases, i.e. they hydrolyze any acid-amide bonds that are located within peptides or proteins. Their optimum pH is usually in the markedly alkaline range. An overview of this enzyme family is discussed in the article “Subtilases: subtilisin-like proteases” by R. Siezen, in “Subtilisin enzymes” pp. 75-95, edited by R. Bott and C. Betzel, New York, 1996. Subtilases are of course formed by microorganisms. For example, the subtilisins formed and secreted by Bacillus species are the most significant group within the subtilases.

Examples of proteases of the subtilisin type preferably used in washing and cleaning agents are the subtilisins BPN′ and Carlsberg, protease PB92, subtilisins 147 and 309, the alkaline protease from Bacillus lentus, in particular from Bacillus lentus DSM 5483, subtilisin DY, and the enzymes (to be classified, however, as subtilases and no longer as subtilisins in the strict sense) thermitase, proteinase K, and the proteases TW3 and TW7. Other usable proteases include the enzymes obtainable under the trade names Durazym®, Relase®, Everlase°, Nafizym, Natalase®, Kannase®, and Ovozyme® from the Novozymes company, under the trade names Purafect®, Purafect® OxP, Purafect® Prime, and Properase® from the Genencor company, under the trade name Protosol® from Advanced Biochemicals Ltd., Thane, India, under the trade name Wuxi® from Wuxi Snyder Bioproducts Ltd., China, under the trade names Proleather® and Protease P® from Amano Pharmaceuticals Ltd., Nagoya, Japan, and under the designation Proteinase K-16 from Kao Corp., Tokyo, Japan.

At best, synergistic effects may occur between the enzymes and the other constituents of the respective washing or cleaning agent.

A disadvantage of these preferred enzymes for use in washing and cleaning agents, and in particular the proteases, is that at low temperatures, (e.g. between 10° C. and 40° C., or between 10° C. and 30° C., or even between 10° C. and 25° C.), they do not have satisfactory hydrolytic activity, in particular proteolytic activity, and therefore do not exhibit optimum cleaning performance in that temperature range.

Therefore, there is a continual need to improve the cleaning performance of washing or cleaning agents, in particular in terms of their ability to remove stains that are sensitive to breakdown by hydrolytic enzymes, e.g. proteases. An additional unmet need is to improve the cleaning performance of hydrolytic enzymes such as proteases in washing or cleaning agents, or in the washing bath formed by the washing or cleaning agent, in terms of stains that are sensitive to breakdown by hydrolytic enzymes such as proteases. Lastly, there remains a need to improve the cleaning performance of hydrolytic enzymes such as proteases in the temperature range between 10° C. and 50° C., and most preferably down into the range of 10° C. to 25° C.

### SUMMARY OF THE INVENTION

It has now been surprisingly found that the addition of certain substances considerably improves the cleaning performance of washing and cleaning agents that contain hydrolytic enzymes, in particular proteases, at the comparatively low temperatures ranges of 10-50° C., 10-40° C., 10-30° C., and 10-25° C.

In an exemplary embodiment of the present invention, a method for improving the cleaning performance of a washing or cleaning agent that encompasses a hydrolytic enzyme such as a protease, amylase, cellulase, hemicellulase, mannanase, tannase, xylanase, xanthanase, β-glucosidase, carrageenase, or lipase, comprises the addition to the washing or cleaning agent of a component capable of producing a synergistic cleaning performance interaction with the hydrolytic enzyme. Such a component comprises: (i) an amino acid or polyamino acid, or derivatives thereof; (ii) a biosurfactant; or (iii) a microbial metabolite, or mixtures thereof, or (iv) a preparation of a microbial culture supernatant that contains at least 2.5 wt % of one of the substances (i), (ii), or (iii).

### BRIEF DESCRIPTION OF THE DRAWING FIGURE

FIG. 1 illustrates the chemical structure of the biosurfactant Surfactin.

### DETAILED DESCRIPTION OF THE INVENTION

It has been ascertained in accordance with the present invention that the cleaning performance of washing or cleaning agents can be significantly improved, in particular in terms of their enzymatic performance e.g. proteolytic cleaning performance, if in such agents, at least one hydrolytic enzyme (herein also referred to as “component (a)”) is combined with one or more of the substances or substance classes listed above as (i) to (iv), (herein also referred to as “component (b)”). “Cleaning performance” is understood to mean the brightening performance on one or more stains, in particular laundry stains, that are sensitive to breakdown by the respective hydrolytic enzyme, and in particular sensitive to breakdown by proteases. Examples of such stains are blood-milk/ink on cotton, whole egg/pigment on cotton, chocolate-milk/ink on cotton, peanut oil-pigment/ink on polyester/cotton, grass on cotton, or cocoa on cotton, especially in the manner indicated below. In accordance with the invention, the washing or cleaning agent that encompasses the hydrolytic enzyme (or the washing or cleaning bath formed by said agent), and the hydrolytic enzyme itself, have a respective cleaning performance. The cleaning performance of the hydrolytic enzyme thus contributes to the cleaning performance of the agent or of the washing or cleaning bath formed by the agent.

The cleaning performance of washing and cleaning agents, with reference to the enzymatic activity used, in particular the proteolytic activity, is improved by the addition of component (b) defined above. In terms of the interaction of components (a) and (b), a synergistic effect results, meaning better performance as compared to the individual performance results of the respective component in one-component systems (i.e. washing or cleaning agents that contain only the hydrolytic enzyme or component (b)), and also with respect to the sum of the individual performance results of components (a) and (b), i.e. the sum of two one-component systems respectively having component (a) and (b) alone. The selected combination of hydrolytic enzyme (a), in particular protease, with a component (b) according to the present invention represents a further possibility for improving the performance capability of washing or cleaning agents in terms of their cleaning performance, in particular their enzyme-based cleaning performance, very particularly in terms of their cleaning performance that is brought about by a contained protease.

The advantage of combining components (a) and (b) appears upon use of the agent in the washing or cleaning bath. A “washing or cleaning bath” is understood as that functional solution containing the washing or cleaning agent that acts on textiles or fabric (washing bath) or hard surfaces (cleaning bath), and which comes in contact with the stains present on textiles or fabrics, or on hard surfaces. The washing or cleaning bath is usually created when the washing or cleaning operation begins and the washing or cleaning agent is dissolved in or diluted with water, for example in a washing machine or in another suitable vessel.

Preferred hydrolytic enzymes for purposes of component (a) include proteases, amylases, in particular α-amylases, cellulases, lipases, hemicellulases, in particular pectinases, mannanases, β-glucanases, and mixtures thereof. Proteases, amylases, and/or lipases and mixtures thereof are particularly preferred, and proteases are very particularly preferred. In principle, these enzymes are of natural origin. Improved variants based on the natural molecules are available for use in washing and cleaning agents and are preferred for use.

Among the proteases, those of the subtilisin type are preferred. Examples thereof are the subtilisins BPN′ and Carlsberg, protease PB92, subtilisins 147 and 309, the alkaline protease from Bacillus lentus, subtilisin DY, and the enzymes (to be classified, however, as subtilases and no longer as subtilisins in the strict sense) thermitase, proteinase K, and proteases TW3 and TW7. Subtilisin Carlsberg is obtainable in further developed form under the trade name Alcalase® from Novozymes A/S, Bagsværd, Denmark. Subtilisins 147 and 309 are marketed by Novozymes under the trade names Esperase® and Savinase®, respectively. The protease variants listed under the designation BLAP® are derived from the protease from Bacillus lentus DSM 5483. Other usable proteases are, for example, the enzymes obtainable under the trade names Durazym®, Relase®, Everlase®, Nafizym®, Natalase®, Kannase®, and Ovozymes® from Novozymes, under the trade names Purafect®, Purafect® OxP, Purafect® Prime, and Properase® from Genencor, under the trade name Protosol® from Advanced Biochemicals Ltd., Thane, India, under the trade name Wuxi® from Wuxi Snyder Bioproducts Ltd., China, under the trade names Proleather® and Protease P® from Amano Pharmaceuticals Ltd., Nagoya, Japan, and under the designation Proteinase K-16 from Kao Corp., Tokyo, Japan. The proteases from Bacillus gibsonii and Bacillus pumilus, which are disclosed in International Patent Applications WO2008/086916 and WO2007/131656, are also preferred.

Examples of amylases usable according to the present invention are the α-amylases from Bacillus licheniformis, from B. amyloliquefaciens, or from B. stearothermophilus, and the further developments thereof improved for use in washing or cleaning agents. The enzyme from B. licheniformus is available from Novozymes under the name Termamyl®, and from Genencor under the name Purastar® ST. Further developed products of these α-amylases are available from Novozymes under the trade names Duramyl® and Termamyl® ultra, from Genencor under the name Purastar® OxAm, and from Daiwa Seiko Inc., Tokyo, Japan, as Keistase®. The α-amylase from B. amyloliquefaciens is marketed by Novozymes under the name BAN®, and derived variants of the α-amylase from B. stearothermophilus are marketed, again by Novozymes, under the names BSG″ and Novamyl®. Additionally to be highlighted for this purpose are the α-amylase from Bacillus sp. A 7-7 (DSM 12368) and the cyclodextrin-glucanotransferase (CGTase) from B. agaradherens (DSM 9948). Also usable are the amylolytic enzymes that belong to the sequence space of α-amylases that is defined in International Patent Application WO 03/002711 A2, and that are described in Application WO 03/54177 A2. Fusion products of the aforesaid molecules are likewise usable. The further developments of the α-amylase from Aspergillus niger and A. oryzae, obtainable from Novozymes under the trade names Fungamyl®, are also suitable. Further usable commercial products are, for example, Amylase-LT® and Stainzyme® or Stainzyme Ultra®, or Stainzyme Plus®, the latter likewise from Novozymes. Variants of these enzymes obtainable by point mutations can also be used according to the present invention.

Examples of lipases or cutinases of use according to the present invention, particularly because of their triglyceride-cleaving activities and ability to generate peracids in situ from suitable precursors, include the lipases obtainable from Humicola lanuginosa (Thermomyces lanuginosus) or further-developed lipases, in particular those having the D96L amino acid exchange. They are marketed, for example, by Novozymes under the trade names Lipolase®, Lipolase® Ultra, LipoPrime®, Lipozyme®, and Lipex®. The cutinases that were originally isolated from Fusarium solani pisi and Humicola insolens are also of use. Additional usable lipases are obtainable from the Amano Company under the designations Lipase CE®, Lipase P®, Lipase B®, or Lipase CES®, Lipase AKG®, Bacillis sp. Lipase®, Lipase AP®, Lipase M-AP®, and Lipase AML®. The lipases and cutinases derived from enzymes originally isolated from Pseudomonas mendocina and Fusarium solanii are of use and available from Genencor. The preparations M1 Lipase® and Lipomax®, originally marketed by the Gist-Brocades company, the enzymes marketed by Meito Sangyo K K, Japan under the names Lipase MY-30®, Lipase OF®, and Lipase PL®, and the Lumafast® product from Genencor are also important commercial products.

Cellulases may be present, depending on the purpose, as pure enzymes, as enzyme preparations, or in the form of mixtures where individual components complement one another in terms of their various performance aspects. These performance aspects include the contributions of cellulase to: (1) the primary washing performance of the agent (i.e. cleaning performance); (2) the secondary washing performance of the agent (anti-redeposition effect or graying inhibition); (3) brighten fabrics (i.e. a fabric effect); or, (4) exert a “stone-washed” effect. A usable fungus-based cellulase preparation rich in endoglucanase (EG), and its further developments, are offered by Novozymes under the trade name Celluzyme®. The products Endolase® and Carezyme®, likewise obtainable from Novozymes, are based on the 50 kD EG and 43 kD EG, respectively, from H. insolens DSM 1800. Further usable commercial products from this company include Cellusoft®, Renozyme®, and Celluclean®. Also usable are the 20 kD EGs from Melanocarpus that are available from the AB Enzymes company, Finland, under the trade names Ecostone® and Biotouch®. Other suitable commercial products from AB Enzymes include Econase® and Ecopulp®. Other suitable cellulases are from Bacillus sp. CBS 670.93 and CBS 669.83, the one from Bacillus sp. CBS 670.93 available from Genencor under the trade name Puradax®. Other commercial products from Genencor include “Genencor detergent cellulase L” and IndiAge® Neutra.

In order to remove certain problematic stains, it is also possible to incorporate other enzymes that are grouped under “hemicellulases.” These enzymes include, for example, mannanases, xanthanlyases, pectinlyases (=pectinases), pectinesterases, pectatelyases, xyloglucanases (=xylanases), pullulanases, and β-glucanases. Enzymes suitable in this context are obtainable, for example, under the names Gamanase® and Pektinex AR® from Novozymes, under the name Rohapec® B1L from AB Enzymes, and under the name Pyrolase® from Diversa Corp., San Diego, Calif. The β-glucanase recovered from Bacillus subtilis is available under the name Cereflo® from Novozymes. Hemicellulases particularly preferred according to the present invention are mannanases, which are marketed under the trade names Mannaway® by Novozymes or Purabrite® by Genencor.

The enzymes may also be prepared with accompanying substances, for example from fermentation, or with stabilizers.

Particularly preferred among all these enzymes are those that are inherently comparatively stable with respect to oxidation, or have been stabilized e.g. by point mutagenesis. Among these, the previously mentioned commercial products Everlase and Purafect® OxP are examples of such proteases. Duramyl is an example of such an α-amylase.

Agents for use in a method according to the present invention preferably contain enzymes in total quantities from 1×10⁻⁸ to 5 wt %, based on active protein. The enzymes are preferably contained in the agents from 0.001 to 5 wt %, more preferably from 0.01 to 5 wt %, and most preferably from 0.05 to 4 wt %. It is particularly preferable that the total quantities of enzyme be from 0.075 to 3.5 wt % such that each enzyme contained can be present in the quantities cited.

The protein concentration can be determined by known methods, for example the BCA method (bichinchoninic acid; 2,2′-biquinolyl-4,4′-dicarboxylic acid) or the biuret method (A. G. Gornall, C. S. Bardawill and M. M. David, J. Biol. Chem., 177 (1948), pp. 751-766).

The hydrolytic enzyme, at least one of which is present (specifically as component (a)) in a washing or cleaning agent that is used in the method according to the present invention, assists the cleaning performance of the agent in terms of certain stains or spots. Particularly preferably, an agent used in a method according to the present invention contains multiple enzymes, such that the enzymes can belong to the same or different enzyme classes. Particularly preferably, the enzymes exhibit synergistic effects in terms of their action with respect to specific stains or spots, i.e. the enzymes contained in the agent composition mutually assist one another in their cleaning performance.

Synergistic effects can exist not only between different enzymes, but also between one or more enzymes and other ingredients present in the washing or cleaning agent in accordance with the present invention. What may be utilized is a hydrolytic enzyme (a) in combination with a component (b). Component (b), which produces a synergistic cleaning performance in interaction with the hydrolytic enzyme (a) upon use of the agent, is selected from:
i. amino acid or polyamino acid or derivative thereof, and/or
ii. biosurfactant, and/or
iii. microbial metabolite, and/or
iv. a preparation of a microbial culture supernatant that contains at least 2.5 wt % of one of substances (i), (ii), or (iii).

The substances indicated under (i) above are preferably amino acids, or polymers, salts, or derivatives of amino acids, wherein either or both stereoisomers (D- or L-) of the amino acids may be used, including in combination, or corresponding polymers or derivatives. A polyamino acid refers herein to at least two amino acid residues. Preferably these include glutamate, polyglutamate, lysine, glutamine, histidine, phenylalanine, tyrosine, alanine, leucine, isoleucine, methionine, proline, valine, gluramine, cysteine, tryptophan, threonine, serine, glycine, aspartate, and asparagine. Charged polyamino acids are preferably used, and among them the negatively charged polyamino acids are the more preferred. Polyaminoglutamic acid, including γ-D-polyglutamic acid, L-polyglutamic acid and D,L-polyglutamic acid, polyaspartic acid, including β-D-polyaspartic acid and L-polyaspartic acid, polyglutamine, including γ-D-polyglutamine, L-polyglutamine and DL-polyglutamine, as well as polyasparagine, including β-D-polyasparagine and L-polyasparagine, are all preferred. An example of a particularly preferred polyaspartic acid is the compound available under the commercial name Baypure® DS 100 fest G (from Lanxess Company).

“Derivatives” herein refers to those substances whose pure amino acid or amino acid chain has been modified. Such derivatizations may have already occurred biologically in conjunction with biosynthesis by the host cell, or can be accomplished using methods of molecular biology. These derivatizations may also be carried out chemically, for example by chemical conversion of a side chain of an amino acid or by covalent bonding of another compound onto the amino acid or amino acid chain. A compound of this kind may refer to low-molecular-weight compounds such as lipids or mono-, oligo-, or polysaccharides, or amines or amine compounds. The amino acids or amino acid chains can also include additional chemical modifications. For example, an amino acid may be glycosylated, hydrolyzed, oxidized, N-methylated, N-formylated, N-acetylated, or may contain methyl, formyl, ethyl, acetyl, t-butyl, anisyl, benzyl, trifluoroacetyl, N-hydroxysuccinimide, t-butyloxycarbonyl, benzoyl, 4-methylbenzyl, thioanizyl, thiocresyl, benzyloxymethyl, 4-nitrophenyl, benzyloxycarbonyl, 2-nitrobenzoyl, 2-nitrophenylsulfenyl, 4-toluenesulfonyl, pentafluorophenyl, diphenylmethyl, 2-chlorobenzyloxycarbonyl, 2,4,5-trichlorophenyl, 2-bromobenzyloxycarbonyl, 9-fluorenylmethyloxycarbonyl, triphenylmethyl, 2,2,5,7,8-pentamethyl-chroman-6-sulfonyl substituents. “Derivatization” is likewise to be understood as including covalent or non-covalent bonding of an amino acid to a macromolecular carrier, and also to include non-covalent inclusion into suitable macromolecular cage structures. Linkages to other macromolecular compounds, such as e.g. polyethylene glycol, can also be performed. Amino acid chains can have further chemical modifications, in which context the amino acid groups —COOH, —OH, ═NH, —NH₂—SH preferably carry the following modifications: —COOR, —OR, —NHR, —NR2, —NHR, —NR, —SR, such that:

R is —CH═CH—R2, —C═C—R2, —C(R2)═CH₂, —C(R2)═C(R3), —CH═NR2, —C(R2)═N—R3, a 4- to 7-carbon ring system with or without substitution, a 4- to 7-nitrogen heterocycle with or without substitution, or a 2- to 8-carbon chain having 1 to 5 double or triple bonds with substitutions selected from R1, R2, or R3;

R1 is H, —R, —NO₂, —CN, -halo, —N₃, C1 to 8 alkyl, —(CH₂)nCO₂R2, —C2 to 8 alkenyl-CO₂R2, —O(CH₂)nCO₂R2, —C(O)NR2R3, —P(O)(OR2)₂, alkyl-substituted tetrazol-5-yl, —(CH₂)nO(CH₂)n aryl, —NR2R3, —(CH₂)nOR2, —(CH₂)nSR2, —N(R2)C(O)R3, —S(O₂)NR2R3, —N(R2)S(O₂)R3, —(CHR2)nNR2R3, —C(O)R3, (CH₂)nN(R3)C(O)R3, —N(R2)CR2R3, substituted or unsubstituted (CH₂)n-cycloalkyl, substituted or unsubstituted (CH₂)n-phenyl, or cyclic;

R2 is H, -halo, -alkyl, -haloalkyl, —(CH₂)n-phenyl, —(CH₂)1 to 3-biphenyl, —(CH₂)1 to 4-Ph-N(SO₂—C1 to 2-alkyl)₂, —CO(CHR1)n-OR1, —(CHR1)n-heterocycle, —(CHR1)n-NH—CO R1, —(CHR-1)n-NH—SO₂R1, —(CHR1)n-Ph-N(SO₂—C1 to 2-alkyl)₂, —(CHR1)n-C(O)(CHR1)—NHR1, —(CHR1)n-C(S)(CHR1)-NHR1, —(CH₂)nO(CH₂)nCH₃, —CF₃, —C2 to 5 acyl, —(CHR1)nOH, —(CHR1)nCO₂R1, —(CHR1)n-O-alkyl, —(CHR1)n-O—(CH₂)n-O-alkyl, —(CHR1)n-S-alkyl, —(CHR1)n-S(O)-alkyl, —(CHR1)n-S(O₂)-alkyl, —(CHR1)n-S(O₂)—NHR3, —(CHR3)n-N₃, —(CHR3)nNHR4, a 2- to 8-carbon atom alkene chain having 1 to 5 double bonds, 2- to 8-carbon alkyne chain having 1 to 5 triple bonds, substituted or unsubstituted—(CHR3)n heterocycle, or substituted or unsubstituted saturated or unsaturated—(CHR3)n cycloalkyl;

such that n is greater than 1 and R1 and R3 can be the same or different;

R3 is H, —OH, —CN, substituted alkyl, C2 to 8 alkenyl, substituted or unsubstituted cycloalkyl, —N(R1)R2, or 5- to 6-carbon saturated or unsaturated heterocycle. —NR2R3 can be made up of a saturated or unsaturated heterocycle or a bicyclic heterocycle of 4 to 7 atoms;

n is 0 to 4;

R4 and R5 are each made up of: H, —(CH₂)nOH, —C(O)OR6, —C(O)SR6, —(CH₂)nC(O)NR7R8, —O—C(O)—O—R7, an amino acid, or a peptide;

R6 is H;

R7 is —C(R7)(R8)-(CH₂)n-O—C(O)—R9, —(CH₂)n-C(R7)(R8)-O—C(O)R9, —(CH₂)n-C(R7)(R8)-O—C(O)—O—R9, or —C(R7)(R8)-(CH₂)n-O—C(O)—O—R9; and

R7, R8, and R9 are each made up of H, alkyl, substituted alkyl, aryl, substituted aryl, alkenyl, substituted alkenyl, alkynyl, substituted alkynyl, heterocycle, substituted heterocycle, alkylaryl, substituted alkylaryl, cycloalkyl, substituted cycloalkyl, or CH₂CO₂ alkyl.

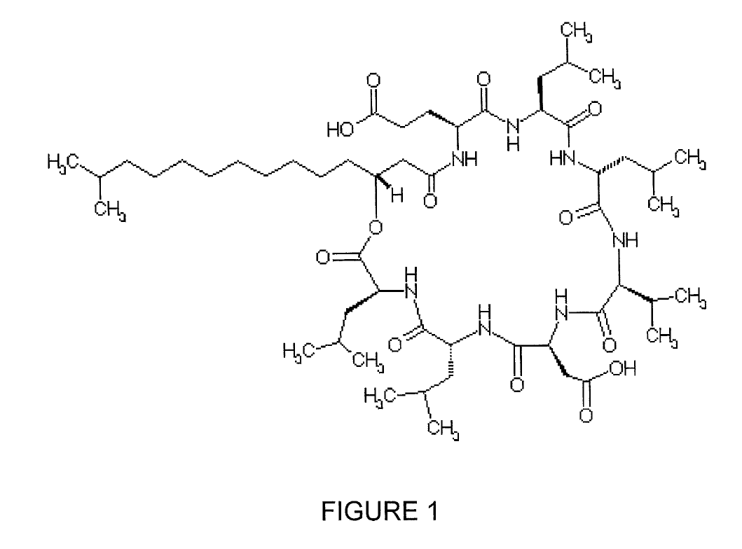

The substances indicated under (ii) above are biosurfactants. Biosurfactants refer to herein as substances formed (and often also secreted) by microorganisms. Like conventional surfactants, biosurfactants are surface-active substances that decrease the surface tension of liquids and thereby promote the mixing of aqueous (hydrophilic) and oil (hydrophobic) phases. Preferred biosurfactants for use in the present invention fall mostly in the group of lipids or lipid derivatives, and in particular lipopeptides. They are therefore bioactive peptidic substances formed by microorganisms. As a rule, they are synthesized nonribosomally by the respective microorganisms, for example by Gram-positive bacteria, in particular the genera Bacillus and Streptomyces, Gram-negative bacteria, in particular the genera Pseudomonas and Myxobacteria, and by filamentous fungi. The peptide chains are preferably made up of two to forty amino acids and can be linear, cyclic, or branched. In contrast to ribosomally synthesized peptide chains, they comprise as monomeric modules not only proteinogenic L-amino acids but also D-amino acids as well as alpha-hydroxycarboxylic acids and/or carboxylic acids of all kinds. The amino acids are L-α- or D-α-amino acids, but β-, γ-, or δ-amino acids can also be present, in both the D- and L-configuration. The peptide chains can also have further chemical modifications. For example, they may be glycosylated, hydrolyzed, N-methylated, or N-formylated. Other frequently occurring structural elements are thiazoline and/or oxazoline rings in various oxidation states. Biosurfactants particularly preferred according to the present invention are anionic lipopeptides and, more preferably, surfactin-like or lichenysin-like substances, or surfactin or lichenysin itself. “Surfactin-like or lichenysin-like substances” are understood as those that either have a chemical structure similar to that of surfactin, shown in FIG. 1, or lichenysin, respectively, and/or an action similar to that of surfactin or lichenysin, respectively. Referring now to FIG. 1, surfactin can be described by the following formula: fatty acid-cyclo-[Glu-Leu-Leu-Val-Asp-Leu-Leu]. Lichenysin can be described in particular by the following formula: fatty acid-cyclo-[Gln-Leu-Leu-Val-Asp-Leu-Ile]Because lichenysin is often also referred to as “lichenisin,” it is important to recognize that according to the present invention, the term “lichenysin” encompasses both terms.

Further biosurfactants, as well as the microorganisms that produce them, are indicated in TABLE 1 below:

TABLE 1
Biosurfactants from Indicated Microorganisms

| Biosurfactant | Microorganism source |
|---|---|
| Trehalose lipids | Arthrobacter paraffineus |
| | Corynebacterium sp. |
| | Mycobacterim sp. |
| | Rhodococcus erythropolis, Norcardia sp |
| Rhamnolipids | Pseudomonas aeruginosa |
| | Pseudomonas sp., Serratia rubidea |
| Sophorolipids | Candida apicola, Candida bombicola |
| | Candida lipolytica |
| | Candida bogoriensis |
| Glycolipids | Alcanivorax borkumensis |
| | Arthrobacter sp., Corynebacterium sp. |
| | R. erythropolis, Serratia marcescens |
| | Tsukamurella sp. |
| Cellobiose lipids | Ustilago maydis |
| Polyol lipids | Rhodotorula glutinus |
| | Rhodotorula graminus |
| Diglycosyl diglycerides | Lactobacillus fermenti |
| Lipopolysaccharides | Acinetobacter calcoacetius (RAG1) |
| | Pseudomonas sp., Candida lipolytica |
| Arthrofactin | Arthrobacter sp. |
| Lichenysin A, lichenysin B | Bacillus licheniformis |
| Surfactin | Bacillus subtilis,Bacillus pumilus |
| Viscosin | Pseudomonas fluorescens |
| Ornithine, lysine peptides | Thiobacillus thiooxidans |
| | Streptomyces sioyaensis |
| | Gluconobacter cerinus |
| Phospholipids | Acinetobacter sp. |
| Sulfonyl lipids | T. thiooxidans |
| | Corynebacterium alkanolyticum |
| Fatty acids (corynomycolic | Capnocytophaga sp. |
| acids, spiculisporic acids, etc.) | Penicillium spiculisporum |
| | Corynebacterium lepus |
| | Arthrobacter paraffineus |
| | Talaramyces trachyspermus |
| | Norcadia erythropolis |
| Alasan | Acinetobacter radioesistens |
| Streptofactin | Streptomyces tendae |
| “Particulate surfactant” (PM) | Pseudomonas marginalis |
| Biosur PM | Pseudomonas maltophila |

The substances indicated under (iii) above are microbial metabolites. These are understood as substances that occur as intermediates or as breakdown products of metabolic processes of the microorganism, or as breakdown products of the nutrient medium resulting from the microorganism. Preferred microbial metabolites are present in the culture medium of a culture of the microorganism that forms them. Most preferably, they are therefore secreted by the microorganism forming them. Examples of microbial metabolites most preferred according to the present invention are diols, in particular 2,3-butanediol, acids, in particular acetate, lactate, pyruvate, 2-methylpropionate, 3-methylbutyrate, α-ketogluterate, propionate, butyrate, buterate, sugars, in particular levan, and, as a further particularly preferred microbial metabolite, acetoin.

Furthermore, microbial metabolites may also be propanediol, glycol, glycerol, citrate, formate, ethanol, methanol, or butanol.

In another embodiment of the present invention, component (b) comprises a preparation of a microbial culture supernatant that contains at least 2.5 wt % of one of substances (i) to (iii) discussed above. The culture medium of a microbial culture preferably contains one of the above-described substances (i), and/or (ii), and/or (iii). The culture supernatant, obtained after removal of the cells or cell fragments containing at least one of the substances, may be used to enhance a washing or cleaning agent with component (b). It is necessary, however, for to add to the washing or cleaning agent a preparation of a microbial culture supernatant of this kind containing at least 2.5 wt % of one of substances (i) to (iii). Alternatively, the preparation contains 3, 3.5, 4, 4.5, 5, 5.5, 6, 6.5, 7, 7.5, 8, 8.5, 9, 9.5, 10, 12, 14, 16, 18, 20, 22, 24, 26, 28, 30, 35, 40, 45, 50, 55, 60, 65, 70, 75, 80, 85, or 90 wt % of one of substances (i) to (iii). The quantities indicated make available a sufficient minimum quantity of the respective substance without negatively influencing the performance of the washing or cleaning from too many additional constituents of the microbial culture supernatant. In the worst case, the washing performance of the washing or cleaning agent would be reduced by the addition of too great a volume of the microbial culture supernatant, which may be avoided on the basis of the minimum quantities of substances (i) to (iii) indicated above. Component (b) is thus contained in the supernatant of a microbial culture. It may have been actively manufactured or secreted by the microorganisms into the supernatant, or it may have arrived in the supernatant as a result of cell lysis events in the culture. It is then possible by well known means in the art (e.g. fractionation) to produce preparations of the culture supernatants containing component (b) in a quantity sufficient to enable utilization according to the present invention. A suitable preparation can therefore also comprise one or more fractions of a culture supernatant. If the culture supernatant already contains component (b) in sufficient quantity, the culture supernatant can also be added directly to the washing or cleaning agent. In this case, the preparation is the culture supernatant itself.

It is also possible to use any combinations of the above-described substances (i) through (iv) in the methods according to the present invention. For example, the natto, or the non-bean portion thereof, obtained with the aid of cultures of Bacillus subtilis natto, may also be used according to the present invention as component (b).

Component (b) is preferably added to the washing or cleaning agent as a separate and distinct substance, i.e. not as a constituent of another ingredient of the washing or cleaning agent. Thus, component (b) is preferably present in the washing or cleaning agent “unconstrained,” meaning it is distributed in the agent as homogeneously as possible. In the case of liquid or gelled washing or cleaning agents, component (b) is preferably dissolved or dispersed therein. It is most preferred that the washing or cleaning agent not contain component (b) as a constituent of the form of hydrolytic enzyme (a) added to the agent, in particular not as a constituent of an enzyme granulate.

Washing or cleaning agents that are liquid or gelled, i.e. not solid, are preferred according to the present invention.

The synergistic washing performance produced by the interaction of component (b) with hydrolytic enzyme (a) when the washing or cleaning agent is in use, is measured in a washing system containing a washing agent dosed at between 4.5 and 7.0 grams per liter of washing bath, as well as for the hydrolytic enzyme (a) and component (b) individually or in combination. In each case, the enzyme is used in an activity-equalized fashion and component (b) at a concentration from 0.00025 to 0.6 wt %, in particular from 0.0003 to 0.5 wt % (utilization concentration in the washing bath), with the washing performance determined with respect to one or more of the following stains: blood-milk/ink on cotton, whole egg/pigment on cotton, chocolate-mills/ink on cotton, peanut oil-pigment/ink on polyester/cotton, grass on cotton, and cocoa on cotton. In particular the following stains were tested by measuring the whiteness of the washed textiles after a minimum 30 minute wash procedure (optimally 60 minutes), at 40° C., with water hardness between 15.5 and 16.5° (German degrees of hardness): blood-milk/ink on cotton (product no. C5 of CFT B.V., Vlaardingen, Holland); whole egg/pigment on cotton (product no. 1 ON obtainable from wfk. Testgewebe GmbH, Brüggen-Bracht, Germany, cut into small pieces); chocolate-milk/ink on cotton (product no. C3 of CFT B.V., Vlaardingen, Holland); peanut oil-pigment/ink on polyester/cotton (product no. PC10 of CFT B.V., Vlaardingen, Holland); grass on cotton (product no. 164 available from Eidgenössische Material und Prëfanstalt (EMPA) Testmaterialien [Federal Materials and Testing Agency, test materials], St. Gallen, Switzerland); and, cocoa on cotton (product no. 112 available from Eidgenössische Material und Prüfanstalt (EMPA) Testmaterialien, St. Gallen, Switzerland.

A preferred liquid washing agent for a washing system of this kind comprises the following composition (all indications in percentage by weight): 0.3 to 0.5% xanthan gum; 0.2 to 0.4% antifoaming agent; 6 to 7% glycerol; 0.3 to 0.5% ethanol; 4 to 7% FAEOS (fatty alcohol ether sulfate); 24 to 28% nonionic surfactants; 1% boric acid; 1 to 2% sodium citrate dehydrate; 2 to 4% soda; 14 to 16% coconut fatty acid; 0.5% HEDP (1-hydroxyethane-1,1-diphosphonic acid); 0 to 0.4% PVP (polyvinylpyrrolidone); 0 to 0.05% optical brighteners; 0 to 0.001% dye; and, remainder deionized water. The dosing ratio of the liquid washing agent is preferably between 4.5 and 5.5 grams agent per liter of wash bath, for example 4.9 grams per liter of washing bath. Washing preferably occurs in a pH range between pH 8 and pH 10.5, and more preferably between pH 8 and pH 9.

A preferred powdered washing agent for a washing system of this kind comprises the following composition (all indications in percentage by weight): 10% linear alkylbenzenesulfonate (sodium salt); 1.5% C₁₂ to C₁₈ fatty alcohol sulfate (sodium salt); 2.0% C₁₂ to C₁₈ fatty alcohol ethoxylate with 7 moles EO; 20% sodium carbonate; 6.5% sodium bicarbonate; 4.0% amorphous sodium disilicate; 17% sodium percarbonate; 4.0% TAED; 3.0% polyacrylate; 1.0% carboxymethyl cellulose; 1.0% phosphonate; 25% sodium sulfate; and, a remainder comprising optional foam inhibitors, optical brighteners, scents, and if applicable, water to make 100%. The dosing ratio of the liquid washing agent is preferably between 6.0 and 7.0 grams per liter of washing bath, for example 6.7 grams per liter of washing bath. Washing preferably occurs in a pH range between pH 9 and pH 11.

A liquid washing agent is preferably used.

The whiteness, i.e. the brightening of the stains, is preferably determined using optical measurement methods, preferably photometrically. A device suitable for this is, for example, the Minolta CM508d spectrometer. The devices used for measurement are usually calibrated beforehand using a white standard, preferably a white standard provided with the particular instrument.

Equal-activity utilization ensures that the respective enzymatic properties, for example the washing performance on specific stains, are compared even if there is some drifting apart of the ratio of active substance to total protein (the values for specific activity). It is generally the case that a low specific activity can be compensated for by adding a larger quantity of protein. Methods for determining enzyme activities are routinely familiar to one skilled in the art of enzyme technology, and commonly applied. Methods for determining protease activity are disclosed, for example, in Tenside, Vol. 7 (1970), pp. 125-132. The protease activity is indicated by preference in protease units (PU). Suitable protease activities, for example, are 5 or 10 PU per ml of washing bath. The enzymatic activity used is not, however, equal to zero.

The synergistic cleaning performance is preferably the result of a novel mechanism of action, i.e. there is no increase in enzyme activity per se in the conventional sense as may be measured (based on proteases) in one of the methods (1 or 2) delineated below. A synergism in accordance with the present invention exists when an increase in cleaning performance is identified in the presence of components (a) and (b) together as compared to the sum of the cleaning performances measured for component (a) alone and component (b) alone, and where component (b) shows no effect in terms of an increase in the hydrolytic activity of component (a), (in particular no increase in the hydrolytic activity of a protease), beyond the measurement-related standard deviation.

### Method 1

The protease activity is determined quantitatively by way of the release of para-nitroanilin (pNA) chromophore from the substrate. The substrate is: suc-L-Ala-L-Ala-L-Pro-L-Phe-p-nitroanilide (substrate solution: 110 mM in DMSO). The protease cleaves the substrate and releases pNA. The release of pNA causes an increase in extinction at 410 nm, the change in which over time is an indication of enzymatic activity (see Del Mar et al., 1979).

Measurement is performed at a temperature of 25° C., at pH 8.6, and a wavelength of 410 nm. The measurement time is 5 min, and the measurement interval 20 s to 60 s.

The utilization buffer (Tris-HCl pH 8.6) is used as a blank sample. 10 μL of the substrate solution is added to each cuvette. For each sample, 1000 μL buffer is placed into a cuvette. From 1 to 300 μl of the buffer or component (b) (0.1, 0.2, 0.5 or 1 wt % in utilization buffer) is placed into the cuvette. From 1 to 300 μl of the protease or the blank sample is placed into the cuvette. Measurement is started by mixing the sample. After mixing, the cuvettes are immediately transferred into the photometer and measurement is started. Activation or stabilization of the protease can be quantified by means of the measured data.

### Method 2

Protease activity is determined via the hydrolysis of casein and subsequent reaction of TCA-soluble peptides with Folin-Ciocalteu phenol reagent. The extinction of the resulting complex is measured at 660 nm and compared with a tyrosine standard. Reaction mixtures contain 3 ml 0.8% (w/v) casein and 0.5 ml of a suitable enzyme dilution with or without component (b) to be tested (concentration 0.1, 0.2, 0.5, or 1 wt %), both in Britton and Robinson's first universal buffer, pH 9.5 (cf. J. Chem. Soc. 1931, p. 1451). The mixtures are incubated for 30 minutes at 25° C., and the reaction is then terminated by adding stop reagent (TCA). In control reactions, the stop reagent is added prior to enzyme addition, with or without the substance to be tested. After 20 minutes at 25° C., the reaction mixtures are filtered through Whatman no. 42 filter paper or centrifuged.

Water, sodium carbonate, and Folin-Ciocalteu phenol reagent are added to the filtrate. After 30 minutes of incubation, extinction at 660 inn is measured. An aliquotted portion of 200 μl of a tyrosine standard is similarly determined. Activity is expressed in protease units, 1 PU being defined as that quantity of proteolytic enzyme resulting in release of 1 mmol tyrosine per minute under defined conditions (cf. Anson, M. L., (1938) J. Gen. Physiol. 22, 79-89, and Folin, O., and Ciocalteu, V., (1929) J. Biol. Chem. 73, 627).

In another embodiment of the method of the present invention, component (b) is contained in a microbial culture supernatant. A bacterial or fungal culture supernatant may be used, in particular a culture supernatant of Bacillus sp., e.g. a culture supernatant of Bacillus subtilis, Bacillus licheniformis, Bacillus pumilus, Bacillus aeolius, or Bacillus subtilis natto. Culture supernatants of these microorganisms encompass at least one and preferably multiple substances of component (b), and can therefore by used in accordance with the present invention. Further microorganisms whose culture supernatants contain a component (b) according to the present invention are selected from the group consisting of the genera Escherichia, Klebsiella, Bacillus, Staphylococcus, Corynebacterium, Arthrobacter, Streptomyces, Stenotrophomonas, and Pseudomonas, and in particular are selected from the group Escherichia coli, Klebsiella planticola, Bacillus licheniformis, Bacillus lentus, Bacillus amyloliquefaciens, Bacillus subtilis, Bacillus alcalophilus, Bacillus globigii, Bacillus gibsonii, Bacillus pumilus, Staphylococcus carnosus, Corynebacterium glutamicum, Arthrobacter oxidans, Streptomyces lividans, Streptomyces coelicolor, and Stenotrophomonas maltophilia.

The substances used as component (b) have specific molecular weights that may contribute to the measured synergistic performance effect. In a further embodiment of the method of the present invention, component: (i) may have a molecular weight (MW) of from 150 to 5×10⁶ Daltons, in particular from 200 to 1×10⁶ Daltons, from 220 to 0.75×10⁶ Daltons, and in particular from 400 to 0.5×10⁶ Daltons; component (ii) may have a molecular weight (MW) from 500 to 3000 Daltons, in particular from 600 to 2500 Daltons, from 700 to 2250 Daltons, and in particular from 800 to 2000 Daltons; and, component (iii) may have a molecular weight (MW) from 150 to 5×10⁶ Daltons, in particular from 200 to 1×10⁶ Daltons, from 220 to 0.75×10⁶ Daltons, and in particular from 400 to 0.5×10⁶ Daltons.

Advantageous synergistic cleaning performance results may further occur from the fact that the substance used as component (b) is present in the washing or cleaning agent at specific concentrations. In another embodiment of the method of the present invention, component: (i) is present in the agent from 0.018 to 0.2 wt %, and in particular from 0.04 to 0.1 wt %; (ii) is present in the agent from 0.001% to 25 wt %, and in particular from 0.005 to 10 wt %; and, (iii) is present in the agent from 0.018 to 0.2 wt %, and in particular from 0.04 to 0.1 wt %.

With regard to use concentration, i.e. the concentration in the washing or cleaning bath, a particularly advantageous synergistic washing performance is likewise obtained by the fact that the substance used as component (b) is present in the washing or cleaning bath at a specific concentration. In a further embodiment of the invention, the method is therefore characterized in that said component is present in the washing or cleaning bath at a concentration from 0.00025 to 0.6 wt %, and in particular from 0.0003 to 0.5 wt %. This advantageous use concentration relates to the above-described components (i), and/or (ii), and/or (iii), and/or (iv).

Included among the washing and cleaning agents of use in the methods according to the present invention are all conceivable types of washing or cleaning agents, both concentrates and agents to be used undiluted, for use on a commercial scale, in washing machines, or for hand laundering or cleaning. Included are, for example, washing agents for textiles, carpets, or natural fibers, for which the term “washing agent” is used. Also included are, for example, dishwashing agents for automatic dishwashers, or manual dishwashing agents, or cleaners for hard surfaces such as metal, glass, porcelain, ceramic, tiles, stone, painted surfaces, plastics, wood, or leather, for which the term “cleaning agent” is used, i.e. in addition to manual and automatic dishwashing agents, also e.g. scouring agents, glass cleaners, toilet fresheners, etc. Further included among the washing and cleaning agents in the context of the invention are washing adjuvant dispensed into the actual washing agent in the context of manual or automatic textile laundering in order to achieve a further effect. Also categorized as washing and cleaning agents in the context of the invention are textile pre-treatment and post-treatment agents, i.e. those agents with which the laundry item is brought into contact prior to actual laundering, for example in order to loosen stubborn stains, and also those agents that, in a step subsequent to actual textile laundering, impart to the laundered item further desirable properties such as a pleasant feel, freedom from wrinkles, or a low static charge. The latter agents include, among others, the fabric softeners.

The washing or cleaning agents usable in methods according to the present invention, which can be present as, in particular, powdered solids, in recompacted particle form, as homogeneous solutions, or suspensions, can in principle contain, in addition to the active substances used according to the present invention—components (a) and (b)—all known ingredients that are usual in such agents, preferably at least one further ingredient being present in the agent. The agents can contain in particular builder substances, surface-active surfactants, bleaching agents based on organic and/or inorganic peroxygen compounds, bleach activators, water-miscible organic solvents, enzymes, sequestering agents, electrolytes, pH regulators, and further adjuvants such as optical brighteners, anti-gray agents, foam regulators, as well as dyes and scents, and combinations thereof. A further combination of the active substances according to the present invention with one or more further ingredient(s) of the agents proves to be advantageous in particular because a further improved cleaning performance can then be achieved by means of further synergisms that occur. A further synergism of this kind is achieved in particular by means of a combination with a surfactant and/or a builder substance and/or a bleaching agent. Such preferred further ingredients of the washing or cleaning agent are disclosed in International Application WO 2009/021867, incorporated herein in its entirety by reference.

The ingredients to be selected, as well as the conditions under which the agent is used, for example temperature, pH, ionic strength, redox relationships, or mechanical influences, should be optimized for the particular cleaning problem. Usual temperatures for the use of washing and cleaning agents are thus in ranges from 10° C. to 40° C. and 60° C., and up to 95° C. for automatic agents or in technical applications. The ingredients of the relevant agents are preferably coordinated with one another, in particular in such a way that synergies result in terms of cleaning performance. Synergies that exist in a temperature range between 10° C. and 60° C., in particular in a temperature range from 10° C. to 50° C., from 10° C. to 40° C., from 10° C. to 30° C., from 15° C. to 30° C., from 10° C. to 25° C., from 15° C. to 25° C., and very particularly preferably at 20° C., are particularly preferred.

In another preferred embodiment, an agent usable in methods according to the present invention further contains the hydrolytic enzyme in a quantity from 2 μg to 20 mg, by preference from 5 μg to 17.5 mg, particularly preferably from 20 μg to 15 mg, and very particularly preferably from 50 μg to 10 mg per g of the agent. The hydrolytic enzyme contained in the agent, where the enzyme is preferably a protease, and/or further ingredients of the agent, may also be encased with a substance that is impermeable to the enzyme at room temperature or in the absence of water, and where such substance becomes permeable to the enzyme under utilization conditions for the agent. An embodiment of the invention of this kind is thus characterized in that the hydrolytic enzyme is encased with a substance that is impermeable to the enzyme at room temperature or in the absence of water. The washing or cleaning agent furthermore can itself be packaged in a container, preferably an air-permeable container, from which it is released shortly before use or during the washing operation.

In further embodiments of the invention, the method is characterized in that the washing or cleaning agent: (1) is present in solid form preferably as a pourable powder having a bulk weight from 300 g/l to 1200 g/l, in particular 500 g/l to 900 g/l; (2) is present in paste or liquid form; (3) is present as a one-component system; or (4) is divided into multiple components.

These embodiments of the present invention further encompass all solid, powdered, liquid, gelled, or pasty administration forms of the agents usable in methods according to the present invention, which if applicable can also be made up of multiple phases and can exist in compressed or uncompressed form. The agent can be present as a pourable powder, in particular having a bulk weight from 300 g/l to 1200 g/l, in particular 500 g/l to 900 g/l, or 600 g/l to 850 g/l. Further included among the solid administration forms of the agent are extrudates, granulates, tablets, or pouches. Alternatively, the agent can also be liquid, gelled, or pasty, for example in the form of a nonaqueous liquid washing agent or a nonaqueous paste, or in the form of an aqueous liquid washing agent or a hydrous paste. The agent can furthermore exist as a one-component system. Such agents are preferably made up of one phase. Alternatively, an agent can also be made up of multiple phases. An agent of this kind is therefore subdivided into multiple components.

Washing or cleaning agents usable in methods according to the present invention may contain exclusively one hydrolytic enzyme, for example a protease. Alternatively, however, they may also contain additional hydrolytic enzymes or other enzymes at a concentration useful for the effectiveness of the agent. All enzymes found in the existing art for these purposes are usable in principle. All enzymes that can display a catalytic effect in the agent are preferably usable as additional enzymes, in particular proteases, amylases, cellulases, hemicellulases, mannanases, tannases, xylanases, xanthanases, β-glucosidases, carrageenases, oxidases, perhydrolases, oxidoreductases or lipases, and mixtures thereof. These enzymes are, in principle, of natural origin, with improved variants based on the natural molecules available for use in washing and cleaning agents and preferred for use.

A further embodiment of the invention is a washing or cleaning method comprising the steps of:
(a) providing a washing or cleaning solution encompassing a washing or cleaning agent containing: a hydrolytic enzyme, in particular a protease, amylase, cellulase, hemicellulase, mannanase, tannase, xylanase, xanthanase, β-glucosidase, carrageenase, or lipase, and most preferably a protease; and, a component that produces a synergistic cleaning performance in interaction with the hydrolytic enzyme upon utilization of the agent, said component selected from the group: (i) amino acid, polyamino acid, or derivatives thereof; (ii) biosurfactant; (iii) microbial metabolite; and, (iv) preparation of a microbial culture supernatant that contains at least 2.5 wt % of (i), (ii), or (iii); and
(b) bringing a textile or a hard surface into contact with the washing or cleaning solution according to (a).

All facts, subjects, and embodiments that are described above for all methods according to the present invention are also applicable to this subject of the invention. Reference is therefore expressly made at this juncture to the disclosure at the relevant location, with the instruction that said disclosure also applies to this subject of the invention.

A method of this kind is advantageous because, as described above, the cleaning performance of a washing or cleaning agent that contains a corresponding hydrolytic enzyme is improved by the addition of a component as indicated. The method is thus advantageous for eliminating corresponding contaminants, in particular protein-containing contaminants, from textiles or hard surfaces. Embodiments of this subject of the invention are represented by hand laundering, manual removal of spots from textiles or from hard surfaces, or automatic methods of cleaning.

Methods for cleaning textiles are generally notable for the fact that, in multiple method steps, various substances having cleaning activity are applied onto the material to be cleaned and are washed out after the contact time, or that the material to be cleaned is treated in another fashion with a washing agent or a solution of said agent. The same applies correspondingly to methods for cleaning hard surfaces.

Because a hydrolytic enzyme, (i.e. component (a)), already possesses hydrolytic activity and displays it even in media that otherwise possess no cleaning power, for example in plain buffer, a further embodiment of the method may comprise only applying a hydrolytic enzyme (a) in a buffer solution or water with added component (b) as the only other component.

All the methods in accordance with the present invention are preferably carried out in a temperature range from 10° C. to 60° C., in particular from 10° C. to 50° C., from 10° C. to 40° C., from 10° C. to 30° C., from 15° C. to 30° C., from 10° C. to 25° C., and from 15° C. to 25° C. A synergistic interaction of components (a) and (b) in terms of cleaning performance particularly exists at these low to moderate washing or cleaning temperatures.

In another embodiment of the present invention, a substance selected from the group: (i) amino acid, polyamino acid, or derivatives thereof; (ii) biosurfactant; (iii) microbial metabolite; and, (iv) preparation of a microbial culture supernatant that contains at least 2.5 wt % of (i), (ii), or (iii), is used to achieve a synergistic cleaning performance in interaction with a hydrolytic enzyme in a washing or cleaning agent upon use of the washing or cleaning agent, and in particular in interaction with a protease, amylase, cellulase, hemicellulase, mannanase, tannase, xylanase, xanthanase, β-glucosidase, carrageenase, or lipase. Most preferably the substance is used to achieve a synergistic cleaning performance in interaction with a protease.

The facts, subjects, and embodiments that are described for washing or cleaning methods according to the present invention are also applicable to this subject of the invention. Reference is therefore expressly made at this juncture to the disclosure at the relevant location, with the instruction that said disclosure also applies to the above use according to the present invention.

In further embodiments: component (i) is present in the washing or cleaning agent from 0.018 to 0.2 wt %, and in particular from 0.04 to 0.1 wt %; component (ii) is present from 0.001% to 25 wt %, and in particular from 0.005 to 10 wt %; and, component (iii) is present from 0.018 to 0.2 wt %, and in particular from 0.04 to 0.1 wt %.

In another embodiment of the present invention, a component from the group: (i) amino acid, polyamino acid, or derivatives thereof; (ii) biosurfactant; (iii) microbial metabolite; and, (iv) preparation of a microbial culture supernatant that contains at least 2.5 wt % of (i), (ii), or (iii), is used to increase the cleaning performance of a hydrolytic enzyme in a washing or cleaning process. As described above, these components (component (b)) interact advantageously, in particular synergistically, with a hydrolytic enzyme (component (a)) so that not only the cleaning performance of a washing or cleaning agent (or the washing bath formed by said agent), but also the cleaning performance of the hydrolytic enzyme itself, is improved. The facts, subjects, and embodiments that are described for washing or cleaning methods according to the present invention are also applicable to this subject of the invention. Reference is therefore expressly made at this juncture to the disclosure at the relevant location, with the instruction that said disclosure also applies to the above use according to the present invention.

Preferred embodiments of uses according to the present invention are further characterized in that the component is contained in a microbial culture supernatant, in particular in a bacterial or fungal culture supernatant, in particular in a culture supernatant of Bacillus sp., and in particular in a culture supernatant of Bacillus subtilis, Bacillus licheniformis, Bacillus pumilus, Bacillus aeolius, or Bacillus subtilis natto. It has emerged that culture supernatants of these microorganisms encompass at least one, preferably multiple components (i) to (iv), and can thus be advantageously utilized according to the present invention. Advantageous cleaning performance results are further obtained, in particular, from the fact that the substances used as component (b) have specific molecular weights. Additional preferred embodiments of uses according to the present invention are accordingly characterized in that component: (i) has molecular weight (MW) of from 150 to 5×10⁶ Daltons, in particular from 200 to 1×10⁶ Daltons, from 220 to 0.75×10⁶ Daltons, and in particular from 400 to 0.5×10⁶ Daltons; component (ii) has molecular weight (MW) from 500 to 3000 Daltons, in particular from 600 to 2500 Daltons, from 700 to 2250 Daltons, and in particular from 800 to 2000 Daltons; and, component (iii) has molecular weight (MW) from 150 to 5×10⁶ Daltons, in particular from 200 to 1×10⁶ Daltons, from 220 to 0.75×10⁶ Daltons, and in particular from 400 to 0.5×10⁶ Daltons.

The following are examples in accordance with the present invention.

### Example 1

The general formulation indicated in TABLE 2 below is a textile washing agent used to ascertain washing performance.

TABLE 2
Textile Washing Agent

| Ingredient | wt % pure substance |
|---|---|
| Xanthan | 0.3 to 0.5 |
| Anti-foaming agent | 0.2 to 0.4 |
| Glycerol | 6 to 7 |
| Ethanol | 0.3 to 0.5 |
| FAEOS | 4 to 7 |
| Nonionic surfactant (FAEO, | 24 to 28 |
| APG, amongst others) | |
| Boric acid | 1 |
| Sodium citrate (dihydrate) | 1 to 2 |
| Soda | 2 to 4 |
| Coconut fatty acids | 14 to 16 |
| HEDP | 0.5 |
| PVP | 0 to 0.4 |
| Optical brightener | 0 to 0.05 |
| Dye | 0 to 0.001 |
| Perfume | 0 to 2 |
| H₂O, demineralized | remainder |

The test formulations were assembled in 48-well plates, each in 1 ml of washing bath, as indicated in TABLE 3. Incubation occurred for 60 minutes at 40° C. with stirring (approx. 600 revolutions per minute (rpm)).

TABLE 3
Test Formulations

| Volume | | Solution |
|---|---|---|
| 420 | μl | 161 to 966 mg textile washing agent |
| | | in 42 ml water or buffer |
| 30 to 530 | μl | 1 to 100 PU/ml protease |
| 30 to 530 | μl | Prepared substance solution |

| | |
|---|---|
| remainder | H₂O |
| | Stain diameter approx. 1 cm |

Round stain pieces (diameter approx. 10 mm) were used, selected from the following stains: blood-milk/ink on cotton (product no. C5 of CFT B.V., Vlaardingen, Holland); whole egg/pigment on cotton (product no. 10N obtainable from wfk Testgewebe GmbH, Brüggen-Bracht, Germany, cut into small pieces); chocolate-milk/ink on cotton (product no. C3 of CFT B.V., Vlaardingen, Holland); peanut oil-pigment/ink on polyester/cotton (product no. PC10 of CFT B.V., Vlaardingen, Holland); grass on cotton (product no. 164 available from Eidgenössische Material und Prüfanstalt (EMPA) Testmaterialien [Federal Materials and Testing Agency, test materials], St. Gallen, Switzerland); and, cocoa on cotton (product no. 112 available from Eidgenössische Material und Prüfanstalt (EMPA) Testmaterialien, St. Gallen, Switzerland.

After incubation, the stains were rinsed three times, dried, and fixed, and the whiteness of the washed textiles was measured as compared with a white standard (d/8, 8 mm, SCI/SCE) that had been normalized to 100% (determination of L value). The measurement was carried out on a colorimeter (Minolta Cm508d) with a 10°/D65 illumination setting. The results obtained are indicated as percentage performance, the difference in reflectance values between the baseline washing agent without substance or enzymes, and the agent with protease, having been normalized to 100%.

The proteases used were the alkaline protease from Bacillus lentus DSM 5483 (WO 92/21760), the protease from Bacillus pumilus in accordance with WO2007/131656, and the protease disclosed in FIG. 2 and SEQ ID NO. 3 of International Application WO 03/057713.

### Example 2

Washing performance was tested using the following pure substances (component (b)): polyglutamate (polyglutamic acid), lysine, phenylalanine, tyrosine, alanine, leucine, proline, cysteine, threonine, serine, glycine, aspartate, asparagine, 2,3-butanediol, pyruvate, propionate, butyrate, levan, and surfactin.

Stock solutions with these substances were prepared, having 0.00001 to 1.5 M substance or 0.0001 to 55% (weight) in water or buffer (phosphate 0.00001 to 1.5 M, pH 6.5 to 8.0, or Tris 0.00001 to 1.5 M, pH 7.5 to 9.0, or Sorensen's buffer pH 7.5 to 9.0, or citrate buffer 0.00001 to 1.5 M, pH 4.5 to 7.0, or acetate buffer 0.00001 to 1.5 M, pH 2.5 to 5.5).

TABLE 4 through TABLE 9 below show the washing performance results obtained for the experimental formulations indicated (the abbreviation “n.d.” denotes “not determined”). The amino acids are listed using standard abbreviations. It is evident that the components (b) that are used produce a synergistic increase in washing performance for washing agents that contain a hydrolytic protease, i.e. component (a). In controls that contain no hydrolytic enzyme (labeled “blank”), components (b) produce no increase in washing performance, so that the increased washing performance must be based on a positive synergistic interaction of components (a) and (b).

TABLE 4

| | | Na | | | | | | 2,3- | |
|---|---|---|---|---|---|---|---|---|---|
| | | propionate | Na | Na | Na | Na | Na | butanediol | 2,3- |
| | | (0.18 mM) | propionate | butyrate (1 mM) | butyrate | pyruvate (1 mM) | pyruvate | (0.5 mM) | butanediol |
| | Protease | blank | (0.18 mM) | blank | (1 mM) | blank | (1 mM) | blank | (0.5 mM) |
| EMPA | 100% | −47% | 127% | −28% | 204% | n.d. | n.d. | n.d. | n.d. |
| 164 | | | | | | | | | |
| PC-10 | 100% | 5% | 124% | 7% | 112% | 4% | 123% | 5% | 106% |
| C-03 | 100% | −51% | 119% | −37% | 118% | −34% | 127% | −43% | 120% |

TABLE 5

| | | Ser (0.5 mM) | | Gly (0.5 mM) | | Asp (0.18 mM) | |
|---|---|---|---|---|---|---|---|
| | Protease | blank | Ser (0.5 mM) | blank | Gly (0.5 mM) | blank | Asp (0.18 mM) |
| EMPA | 100% | 13% | 150% | −34% | 141% | −33% | 172% |
| 164 | | | | | | | |
| PC-10 | 100% | 11% | 129% | −4% | 140% | 2% | 126% |
| C-03 | 100% | 3% | 133% | 13% | 125% | −46% | 192% |

TABLE 6

| | | Asn (0.5 mM) | | Cys (0.18 mM) | | Thr (1 mM) |
|---|---|---|---|---|---|---|
| | Protease | blank | Asn (0.5 mM) | blank | Cys (0.18 mM) | blank |
| EMPA | 100% | −38% | 159% | 1% | 147% | 42% |
| 164 | | | | | | |
| PC-10 | 100% | −7% | 138% | 4% | 130% | 0% |
| 10N | 100% | 10% | 263% | 15% | 213% | −5% |

| | | Tyr 0.5-1 mM | | Pro 1 mM | | Ala 1 mM | |
|---|---|---|---|---|---|---|---|
| | Thr (1 mM) | blank | Tyr 0.5-1 mM | blank | Pro 1 mM | blank | Ala 1 mM |
| EMPA | 167% | −26% | 106% | −54% | 111% | n.d. | n.d. |
| 164 | | | | | | | |
| PC-10 | 127% | n.d. | n.d. | 1% | 105% | −6% | 110% |
| 10N | 215% | 1% | 110% | 6% | 108% | 1% | 107% |

TABLE 7

| | Protease | Leu 1 mM | Leu 1 mM | L-Lys (1:10) | L-Lys (1:10) | Phe (1:20) | Phe (1:20) |
|---|---|---|---|---|---|---|---|
| EMPA | 100% | −36% | 106% | −44% | 112% | −40% | 114% |
| 164 | | | | | | | |
| PC-10 | 100% | 1% | 113% | 7% | 117% | n.d. | n.d. |
| 10N | 100% | 10% | 126% | −4% | 122% | 6% | 110% |

TABLE 8

| | | Poly-L-glutamic acid | Poly-L-glutamic acid |
|---|---|---|---|
| | Protease | 15,000-50,000 (0.1%) | 50,000-100,000 (0.1%) |
| PC-10 | 100% | 131% | 151% |
| 10N | 100% | 166% | 171% |
| C-03 | 100% | 126% | 123% |

TABLE 9

| | | Levan (0.018%) | Levan |
|---|---|---|---|
| | Protease | blank | (0.018%) |
| EMPA | 100% | −5% | 135% |
| 164 | | | |
| PC-10 | 100% | −22% | 112% |
| EMPA | 100% | −4% | 154% |
| 112 | | | |

### Example 3

Washing performance was increased with bacterial or fungal fermenter supernatants and nutrient media (culture supernatants) or fractions from the purification of these liquids, in particular with Bacillus fermenter supernatants and Bacillus nutrient media (culture supernatants) and fractions that contain such substances.

Fermenter cultures were centrifuged or not centrifuged in order to separate out solids, and boiled (15 min., 97.5 to 100° C.) in order to inactivate the enzymes. Once the broth had been boiled, the resulting solution was centrifuged again in order to separate out the precipitate that had formed (=boiled supernatant). The boiled supernatant was further treated, as applicable, by being filtered using a 10 kDa cutoff membrane, then through a 1 kDa cutoff membrane. The filtrate of the 1 kDa cutoff membrane was further fractionated using a Bio-Gel P2 column (gel permeation chromatography/size exclusion chromatography).

Culture supernatants or dilutions of two different cultures of Bacillus sp. (strain 1 and strain 2) were thus used as component (b), as well as variously processed and/or fractionated preparations of the supernatants, as respectively indicated.

TABLE 10 through TABLE 15 below show the washing performance results obtained. It is evident that the components (b) used produce a synergistic increase in washing performance of washing agents containing a hydrolytic protease, i.e. component (a). It is further evident, on the basis of the differing effectiveness of individual fractions, that the effect is based on individual, distinct constituents of the supernatants that are contained in the respective fractions, for example in size-dependent fashion.

TABLE 10

| | | Super- | Supernatant, | Supernatant, | Fractionated |
|---|---|---|---|---|---|
| | Pro- | natant, | boiled, | boiled, | 1 kDa |
| | tease | boiled | 10 kDa fraction | 1 kDa fraction | fraction |
| EMPA | 100% | 177% | 257% | 234% | 234% |
| 164 | | | | | |
| PC-10 | 100% | 128% | 120% | 128% | 128% |
| C-03 | 100% | 138% | 113% | 128% | 128% |

TABLE 11
(Part 1)

| | Pro- | Fraction | Fraction | Fraction | Fraction | Fraction |
|---|---|---|---|---|---|---|
| | tease | 9 | 10 | 11 | 12 | 13 |
| EMPA | 100% | 51% | 64% | 84% | −5% | 60% |
| 164 | | | | | | |
| PC-10 | 100% | 99% | 108% | 120% | 130% | 122% |
| C-03 | 100% | 195% | 126% | 141% | 318% | 235% |

(Part 2)

| | Fraction | Fraction | Fraction | Fraction | Fraction | Fraction |
|---|---|---|---|---|---|---|
| | 14 | 15 | 16 | 17 | 18 | 19 |
| EMPA | 101% | 201% | 192% | 100% | 35% | 72% |
| 164 | | | | | | |
| PC-10 | 157% | 182% | 169% | 126% | 115% | 97% |
| C-03 | 199% | 318% | 326% | 138% | 86% | 91% |

TABLE 12

| | Strain 1 | Strain 2 | Strain 1 | Strain 2 | Strain 1 | Strain 2 | Strain 1 | Strain 2 | Protease | Protease |
|---|---|---|---|---|---|---|---|---|---|---|
| | 1:3 | 1:3 | 1:10 | 1:10 | 1:25 | 1:25 | 1:56.6 | 1:56.6 | n.d. | n.d. |
| EMPA | 103% | 108% | 219% | 203% | 181% | 148% | 174% | 133% | 78% | 100% |
| 164 | | | | | | | | | | |
| PC-10 | 87% | 77% | 137% | 135% | 138% | 140% | 131% | 124% | 103% | 100% |
| C-03 | 173% | 132% | 260% | 267% | 230% | 142% | 197% | 180% | 136% | 100% |

TABLE 13

| | Strain 1 | Strain 2 | Strain 1 | Strain 2 | Strain 1 | Strain 2 | Strain 1 | Strain 2 | Protease | Protease |
|---|---|---|---|---|---|---|---|---|---|---|
| | 1:100 | 1:100 | 1:200 | 1:200 | 1:500 | 1:500 | 1:800 | 1:800 | n.d. | n.d. |
| EMPA | 114% | 119% | 84% | 105% | 56% | 56% | 71% | 116% | 78% | 100% |
| 164 | | | | | | | | | | |
| PC-10 | 118% | 111% | 115% | 96% | 104% | 104% | 107% | 104% | 103% | 100% |
| C-03 | 163% | 138% | 110% | 115% | 139% | 130% | 110% | 103% | 136% | 100% |

TABLE 14

| | Fermenter | | Fermenter broth |
|---|---|---|---|
| | broth | Protease | extract + protease |
| | extract | (purified) | (purified) |
| 10N | −19% | 100% | 144% |
| C-03 | −134% | 100% | 174% |
| EMPA | 12% | 100% | 147% |
| 112 | | | |

TABLE 15

| | | | | | | Ferm. | Ferm. | Ferm. | Ferm. |
|---|---|---|---|---|---|---|---|---|---|
| | | Fermenter | Ferm. | Ferm. | Ferm. | supern. | supern. | supern. | supern. |
| | | supernatant | supern. | supern. | supern. | 1:10 + | 1:25 + | 1:200 + | 1:800 + |
| | Protease | 1:10 | 1:25 | 1:200 | 1:800 | protease | protease | protease | protease |
| EMPA | 100% | −66% | 50% | 63% | −93% | 348% | 354% | 317% | 174% |
| 164 | | | | | | | | | |
| C-03 | 100% | 4% | 0% | 4% | 3% | 147% | 134% | 127% | 100% |
| EMPA | 100% | 71% | 139% | 115% | 74% | 90% | 132% | 189% | 108% |
| 112 | | | | | | | | | |

### Example 4

Washing performance was obtained using surfactin or lichenysin, or fermented supernatants of microorganisms that produce surfactin, lichenysin, or similar molecules of the lipopeptide type. Surfactin or surfactin-like molecules were detected by mass spectroscopy in the fermented supernatants.

TABLE 16 through TABLE 19 below show the washing performance results obtained. It is evident that the components (b) used produce a synergistic increase in washing performance for washing agents containing a hydrolytic enzyme, namely a protease, i.e. component (a). In controls that contain no hydrolytic enzyme, the components (b) produce no increase in washing performance. Therefore, the increased washing performance must be based on the positive synergistic interaction of components (a) and (b). The result of an inactivated hydrolytic enzyme (see Table 19) is also no synergistic cleaning performance. These results further demonstration the specific advantageous interaction of components (a) and (b) in accordance with the present invention.

TABLE 16

| | | | Protease |
|---|---|---|---|
| | Protease | | (Bacillus lentus DSM |
| | (Bacillus lentus | | 5483) + 40 μg/ml |
| | DSM 5483) | 40 μg/ml surfactin | surfactin |
| EMPA 164 | 100% | 12% | 123% |
| PC-10 | 100% | −5% | 108% |
| C-5 | 100% | 21% | 109% |

TABLE 17

| | Protease | | Protease per |
|---|---|---|---|
| | per WO | 40 μg/ml | WO 03/057713 + |
| | 03/057713 | surfactin | 40 μg/ml surfactin |
| 10N | 100% | 12% | 120% |
| EMPA 112 | 100% | −5% | 118% |
| C-5 | 100% | 21% | 115% |

TABLE 18

| | | | Protease per |
|---|---|---|---|
| | Protease | | WO2007/131656 + |
| | per | 40 μg/ml | 40 μg/ml |
| | WO2007/131656 | surfactin | surfactin |
| PC-10 | 100% | 12% | 135% |
| 10N | 100% | −5% | 135% |
| C-03 | 100% | 21% | 140% |

TABLE 19

| | Protease per | Protease per WO | | | | |
|---|---|---|---|---|---|---|
| | WO | 2007/131656, | Protease per WO | Protease per WO | Protease per WO | Protease per |
| | 2007/131656, | boiled + 20 μg/ml | 2007/131656, boiled + | 2007/131656 + 20 μl/mg | 2007/131656 + 40 μl/mg | WO |
| | boiled | surfactin | 40 μg/ml surfactin | surfactin | surfactin | 2007/131656 |
| 10N | 10% | 16% | 14% | 114% | 117% | 100% |
| C-03 | −14% | −24% | −25% | 120% | 114% | 100% |
| C-5 | −3% | 10% | 12% | 110% | 128% | 100% |

We claim:

1. A method for improving the cleaning performance of a washing or cleaning agent, said method comprising the steps of:
a) providing a washing or cleaning agent comprising a hydrolytic enzyme;
b) adding to said washing or cleaning agent a component selected from the group consisting of:
(i) an amino acid, a polyamino acid, or derivatives thereof;
(ii) a biosurfactant; and
(iii) a microbial metabolite,
and mixtures thereof; or
c) adding to said washing or cleaning agent a preparation of a microbial culture supernatant that contains at least 2.5 wt % of (i), (ii), or (iii); and
wherein said component (i), (ii), or (iii) synergistically interacts with said hydrolytic enzyme to improve the cleaning performance of said washing or cleaning agent.

2. The method of claim 1, wherein said hydrolytic enzyme is a protease, amylase, cellulase, hemicellulase, mannanase, tannase, xylanase, xanthanase, β-glucosidase, carrageenase, or lipase.

3. The method of claim 2, wherein said hydrolytic enzyme is a protease.

4. The method of claim 1, wherein said microbial culture supernatant is of bacterial or fungal origin.

5. The method of claim 4, wherein said microbial culture supernatant is prepared from a bacterium selected from the group consisting of Bacillus subtilis, Bacillus licheniformis, Bacillus pumilus, Bacillus aeolius, and Bacillus subtillis natto, and mixtures thereof.

6. The method of claim 1, wherein component (i) has a molecular weight of 150 to 5×10⁶ Daltons, component (ii) has a molecular weight of 500 to 3000 Daltons, and component (iii) has a molecular weight of 150 to 5×10⁶ Daltons.

7. The method of claim 1, wherein component (i), if added, is present in said washing or cleaning agent at from 0.018 to 0.2 wt %, component (ii), if added, is present in said washing or cleaning agent at from 0.001 to 25 wt %, and component (iii), if added, is present in said washing or cleaning agent at from 0.018 to 0.2 wt %.

8. The method of claim 1, wherein said component is present in a washing or cleaning bath derived from the dissolution of said washing or cleaning agent in water at a concentration of from 0.00025 to 0.6 wt % based on the total weight of the washing or cleaning bath.

9. The method of claim 1, wherein said hydrolytic enzyme is present in said washing or cleaning agent at from about 2 μg to 20 mg, and wherein said hydrolytic enzyme present in the washing or cleaning agent is encased with a substance that remains impermeable to the enzyme at room temperature or in the absence of water.

10. The method of claim 1, wherein said washing or cleaning agent comprises a solid, a paste, or a liquid form.

11. The method of claim 10, wherein said washing or cleaning agent comprises a solid having a bulk density of from 300 g/l to 1200 g/1.

12. The method of claim 10, wherein said washing or cleaning agent comprises a one-component system.

13. The method of claim 10, wherein said washing or cleaning agent comprises multiple components.

14. A method for washing textiles or cleaning hard surfaces, said method comprising the steps of:
a) providing a washing or cleaning agent that comprises: a hydrolytic enzyme; a component capable of synergistic interaction with the enzyme, said component selected from the group consisting of:
(i) an amino acid, a polyamino acid, or derivatives thereof;
(ii) a biosurfactant; and
(iii) a microbial metabolite,
and mixtures thereof;
or a preparation of a microbial culture supernatant that contains at least 2.5 wt % of (i), (ii), or (iii);
b) dissolving said agent in water to produce a washing or cleaning solution; and
c) bringing a textile or a hard surface into contact with said washing or cleaning solution.

15. The method of claim 14 conducted at a temperature of from about 10° C. to about 60° C.

16. The method of claim 14 conducted at a temperature of from about 15° C. to about 25° C.

17. The method of claim 14, wherein said hydrolytic enzyme is a protease, amylase, cellulase, hemicellulase, mannanase, tannase, xylanase, xanthanase, β-glucosidase, carrageenase, or lipase.

18. The method of claim 14, wherein component (i) has a molecular weight of 150 to 5×10⁶ Daltons, component (ii) has a molecular weight of 500 to 3000 Daltons, and component (iii) has a molecular weight of 150 to 5×10⁶ Daltons.

19. The method of claim 14, wherein component (i), if added, is present in said washing or cleaning agent at from 0.018 to 0.2 wt %, component (ii), if added, is present in said washing or cleaning agent at from 0.001 to 25 wt %, and component (iii), if added, is present in said washing or cleaning agent at from 0.018 to 0.2 wt %.

20. A method for increasing the enzymatic stain removal performance of a washing or cleaning agent, said method comprising the steps of:
a) providing a washing or cleaning agent comprising a hydrolytic enzyme;
b) adding to said washing or cleaning agent a component selected from the group consisting of:
(i) an amino acid, a polyamino acid, or derivatives thereof;
(ii) a biosurfactant; and
(iii) a microbial metabolite,
and mixtures thereof; or
c) adding to said washing or cleaning agent a preparation of a microbial culture supernatant that contains at least 2.5 wt % of (i), (ii), or (iii); and
wherein said component (i), (ii), or (iii) synergistically interacts with said hydrolytic enzyme to improve the enzymatic stain removal performance of said washing or cleaning agent.
